(19) United States
(12) Patent Application Publication
(10) Pub. No.: US 2007/0110544 A1
(43) Pub. Date: May 17, 2007

(54) Light metal thread-forming screw fastener and method for making same

(75) Inventors: Heinrich Friederich, Gross-Rohrheim (DE); Bernhard Reck, Breidenbach (DE)

Correspondence Address: Michael B. Lasky;Altera Law Group, Suite 100, 6500 City West Parkway, Minneapolis, MN, 55344-7704, US

(73) Assignee: EJOT VERBINDUNGSTECHNIK GMBH & CO. KG

(21) Appl. No.: 11/633,354

(22) Filed: Dec. 4, 2006

Related U.S. Application Data
(63) Continuation of application No. 09/798,442, filed on Mar. 2, 2001.
Application No. 09/798,442 is a continuation of application No. PCT/EP99/05925, filed on Aug. 12, 1999.

(30) Foreign Application Priority Data
Sep. 4, 1998 (DE) 198 40 298.8

(51) Int. Cl. F16B 35/04; F16B 25/10

(52) U.S. Cl. 411/387.4; 411/901; 411/411

(57) ABSTRACT

The invention provides a self-screwthread-forming screw comprising an artificially ageable light metal alloy as the screw material, whose shank is provided with a screwthread having screwthread flanks, and which is distinguished in that in at least one region of the screw by virtue of a differing heat treatment the material has a different structure from in the rest of the screw. The invention also provides a process for the production of a screw having the following process steps: forming the screw by rolling or cutting production of the screwthread geometry, solution heat treatment of the screw, quenching of the screw in water, and artificial ageing of the screw, in which the screw if subjected to differing heat treatment in various portions thereof.

The application is a continuation of application Ser. No. 09/798,442, filed 2 Mar. 2001 which is a continuation of PCT/EP99/05925. The application is incorporated herein by reference.

### FIELD OF INVENTION

The invention relates to a thread-forming screw fastener made of a heat-curable light metal alloy with a shaft having a screw thread displaying flanks and at one end a thread-forming and, if required, hole-tapping cone point. The invention also relates to a method for making such screw fasteners.

### BACKGROUND OF THE INVENTION

Light metals have a much lower density in comparison to other metals such as steel and iron, and thus have a lower weight per volume ratio. For this reason light metal components are used wherever it is important to save weight, e.g. in automotive engineering. Many light metal components are manufactured from aluminium, zinc or magnesium alloys by pressure die-casting. However, this can cause problems when such components are fastened together with traditional, known thread-forming screws made of case-hardened, heat-treated or high-grade brands of steel. Signs of corrosion can frequently arise in the contact area beneath the head of a screw fitting joining components made of magnesium alloys which have not been surface-coated or after-treated and in which the fasteners are of case-hardened, heat-treated or high-grade brands of steel, particularly in cases in which the screw fitting is exposed to corrosive media.

The cause of such contact corrosion lies in the widely differing electrochemical rest potentials exhibited by the light metal components and steel fasteners respectively. This contact corrosion considerably restricts the operational safety of such screw fittings. Although contact corrosion may be reduced by applying special coating systems to the case-hardened, heat-treated or high-grade steel fasteners used, it cannot be entirely prevented. An additional problem in a screw fitting joining light metal components with steel fasteners stems from the different expansion coefficients of light metals and steel. The industrial application of magnesium components as such is limited due to the relaxation behaviour of this material as soon as it is subject to slight rises in temperature. If steel fasteners are used to join these components, the different thermal expansion coefficients of the two materials produce considerable fluctuations in the tightening force of the screw fitting. This further restricts the industrial application of magnesium components.

### SUMMARY OF THE INVENTION

The object of the present invention is to prevent as far as possible the disadvantages arising in the prior art.

According to the invention, this objective can be achieved with a thread-forming screw fastener of the type described at the outset, in which the material exhibits a different microstructure in at least one portion of the fastener from that in the remainder as a result of different heat treatment.

A fastener of this type can incorporate two apparently conflicting properties, namely at least one portion displaying the maximum possible strength properties permitted by the material and another portion displaying maximum possible corrosion resistance in the material used. The invention is based on the knowledge that components made of heat-cured aluminium alloys—particularly those containing Cu—tend to be susceptible to stress crack corrosion when heat-treated for maximum strength. This effect is attributable to the formation of coherent and incoherent precipitation, also in the grain crystallite boundary domain, during hot age-hardening and/or precipitation treatment. This can lead to inter-crystalline corrosion.

The microstructure of the material in one portion of the fastener can be adjusted to allow this segment to display extremely high strength properties with a possible reduction in corrosion resistance, whereas the material in the remainder of the fastener displays maximum corrosion resistance even when subjected to tensile stress. A preferred embodiment of the fastener is one which has a thread-forming cone point at one end of the shaft; the material in this thread-forming point portion has a microstructure which gives the material a special strength, while the rest of the fastener material has a microstructure providing it with particularly good corrosion resistance properties.

A screw-shaped fastener is known from U.S. Pat. No. 5,755,542 A; although this fastener is manufactured in one piece from the same base material, it has zones displaying different material properties over its overall length. Nevertheless, even if this is not expressly stated in the specification, the base material concerned in this patent must be steel; light metal could never display a Rockwell hardness of at least 50 RH (Column 2, lines 60/61 and Claim 9; a greater degree of hardness can practically never be achieved for light metal than approx. 30 RH). Identity with the subject-matter of the invention exists in the fact that greater hardness of the base material is provided for in the cone point portion of the fastener than in the remainder of the fastener. However, this deviation in material properties in the remainder of the fastener is meant to relate to greater softness, thus producing a close contact between the fastener threads and the surrounding material of the component in its final, tightened condition (Column 5, lines 60-65). In contrast, the present invention provides maximum possible corrosion resistance in the remaining portion of the light metal fastener.

Such a differentiated type of microstructure in the material over different portions of the fastener can be achieved, for example, by applying different forms of heat treatment on a portion-by-portion basis. However, it is also possible to change the microstructure of the fastener material by mechanical forming. Said mechanical forming may similarly be confined to one part of the fastener. It may equally well be carried out after heat treatment, for example following hot age-hardening. The form of mechanical forming used could then consist, for example, in rolling the fastener thread.

The preferable form of material is a wrought aluminium alloy for at least part of the fastener, containing the following constituents in the stated concentrations:

| | |
|---|---|
| Silicon: | 0.1 to 0.5% |
| Iron: | 0 to 0.5% |
| Copper: | 0.5 to 2.5% |
| Manganese: | 0.1 to 0.4% |
| Magnesium: | 2.0 to 3.9% |
| Chromium: | 0 to 0.3% |
| Zinc: | 4.0 to 8.5% |
| Titanium: | 0 to 0.2% |
| Zirconium: | 0 to 0.25%. |

If light metal components, for example magnesium components, are joined together with fasteners conforming to the invention, those problems outlined at the beginning do not arise because magnesium and aluminium have the virtually identical thermal expansion coefficients of 27×10⁻⁶ per K⁻¹ (magnesium) and 23.6×10⁻⁶ per K⁻¹ (aluminium), respectively, in the 20 to 100° C. temperature range. The corrosion potentials of the two metals are also similar, namely −1.67 Volts for magnesium and −0.83 Volts for aluminium.

Fasteners made of the wrought aluminium alloy specified above can also fulfil a further requirement, namely to provide sufficient hardness in the flanks of the thread. A high degree of thread flank hardness is a prerequisite for a fastener forming its own thread in a component, in order to dispense with the process of cutting the thread in this component, as would otherwise be required. Only then can aluminium fasteners compete as thread-forming fasteners with steel screws as far as manufacturing costs are concerned.

The types of fasteners preferred are thread-forming screw fasteners of the aforementioned specification in which at least the thread flanks have been anodised and thus have oxide layers. Such an oxide layer considerably enhances the surface hardness of the screw fastener and is largely responsible for being able to use such a screw as a thread-forming fastener. If the materials to be joined are of insufficient hardness or strength, a slide coating on the surface of the screw fastener is sufficient to ensure that the counter-thread is formed correctly. Under more demanding conditions, a hard anodised layer can improve the driving properties of the fastener.

The oxide layers preferred for the aforementioned fastener are those impregnated with friction-reducing agents, for example Teflon impregnating compounds. Such impregnating compounds can considerably reduce the friction between the surface of the fastener and the component into which it is being driven. The forces acting on the fastener are also reduced accordingly so that it is subject to less stress. Conversely, this means that the screw fastener can still also be used where its strength would otherwise not be sufficient if the level of friction were not reduced.

The fastener should preferably also have a slide coating, at least on the flanks of the thread. Such a slide coating can further reduce the friction forces described above so that the aforementioned advantages become even more significant. In principle, thread-forming aluminium fasteners can be manufactured having different geometries adapted to the various applications for which they are to be employed and suitable for general use as thread-forming fasteners.

The preferred types of fasteners are those in which the flanks display protrusions extending beyond the exterior diameter of the thread. Such protrusions are preferably to be arranged in such a way as to produce at least one helical line running round the shaft of the fastener along which the protrusions are aligned. In the case of a fastener having a specific flank lead, the helical line running round the shaft should preferably have a lead which is considerably greater than that of the thread. Fasteners having such a geometry are known from German patent specification no. 27 03 433, but not as fasteners made from wrought aluminium alloy. Experiments have shown that good screw fitting results are to be achieved with aluminium fasteners having such a shape.

The object of the invention is also achieved with a method for making a fastener conforming to the specifications of the invention and which comprises the following steps:
forming the fastener by rolling or cutting to generate the thread geometry,
solution annealing of the fastener,
quenching the fastener in water, and
hot age-hardening of the fastener, whereby it is heat-treated differently over separate portions.

Said portion-by-portion method of heat treatment during hot age-hardening of the fastener makes it possible to set different material microstructures selectively over separate portions of the fastener. Such selective setting of different properties over the entire length of the fastener is scarcely possible by the traditional means of heat treatment in furnaces, as homogenous temperatures are naturally generated in the whole fastener in these furnaces, producing correspondingly homogenous properties over its entire length and cross-section.

Whereas prior art solution annealing (U.S. Pat. No. 5,755,542 A) imbues the entire fastener with maximum possible hardness when applied to the fastener with subsequent quenching in water, partial heating (hot age-hardening) in only the remaining portion of the fastener (outside of the cone point) leads to “over-ageing” in this portion, which in turn gives rise to the maximum corrosion resistance required.

However, different temperature levels can be produced in separate portions of the fastener by means of induction heating. In order to achieve this, the fasteners are heated separately in coils, also called inductors. The appropriate alignment makes it possible to subject the fastener head and the length of thread transferring the tightening force to a temperature and time sequence which generates a material condition of maximum corrosion resistance, while that portion of the fastener responsible for thread forming in the vicinity of the cone point is simultaneously subjected to a different temperature and time sequence in order to achieve maximum possible material hardness. The respective optimum parameters (temperature, time) for this process of heat treatment are dependent on the chemical composition of the fastener material in each case.

Heat treatment of the fastener during hot age-hardening is preferably performed in that portion of the fastener away from the head in such a way as to produce maximum microstructural hardness at this location, i.e. so that this portion of fastener material assumes a microstructure of maximum hardness. Correspondingly, heat treatment of the fastener should preferably be carried out in such a way that the overall fastener assumes the property of maximum corrosion resistance except for that portion at the end away from the head.

If the finished fasteners are to have a screw head, the process stage of forming the fastener includes pressing of the appropriate head geometry before that of rolling or cutting to generate the thread geometry. In addition, the fastener is best pickled before being solution annealed. Solution annealing and hot age-hardening subsequently take place in various stages of different duration and at different temperatures. This form of treatment makes it possible to produce the characteristics of optimum strength and toughness. The appropriate temperatures and periods of duration are dependent on the exact material composition in each case.

In a preferred example for this application, solution annealing should best be conducted at temperatures of between 460° C. and 520° C.—preferably at 470° C. to 480° C.

In a preferred variation of the process, the thread geometry is best generated after hot age-hardening by rolling or machining. This means forming of the fastener in this variation of the method is initially confined to pressing the head geometry. The fastener is then pickled, solution annealed and subjected to hot age-hardening. Generation of the thread geometry by rolling or alternatively by machining then constitutes the final stage, thus achieving greater strength and hardness in the flanks portion. Rolling of the thread produces a further change in the microstructure of the fastener material as a result of the mechanical forming operation, which increases the strength of the microstructure in the portion thus formed.

It is also feasible to heat the fastener inductively for solution annealing, which considerably reduces in an advantageous manner the process times required for solution annealing.

In order to achieve thread flanks with a hardness of >350 HV 0.3, the fastener can be partially or wholly anodised, i.e. subjected to anodic oxidation. This produces a hard oxide layer on the surface of the fastener. These oxide layers can ultimately be given additional impregnation to reduce friction, e.g. through Teflon compound impregnation. This also achieves the advantages described above, which can be further intensified by subsequently applying a slide coating to the fastener. This slide coating acts to lower the friction coefficient when the thread is subsequently formed. It also reduces plastic deformation of the flanks during thread formation.

A further advantage of such a fastener over and above those already stated is that—in contrast to steel screws—a fastener made of wrought aluminium alloy can also play a part in lowering the weight of screwed components.

### BRIEF DESCRIPTION OF THE DRAWINGS

The two variants of the manufacturing method are described in detail below, as are embodiments of fasteners conforming to the invention, said embodiments being illustrated with the aid of Figures. Said Figures show the following examples:

FIG. 1 Thread-forming fastener with cheesehead;

FIG. 2 Thread-forming fastener with hexagon head and scrape slots;

FIG. 3 Self-drilling fastener;

FIG. 4 Self-drilling fastener with extrusion hole forming shaft portion;

FIG. 5 Extrusion hole forming, self-drilling fastener with scrape slots; and

FIG. 6 Alternative extrusion hole forming fastener without scrape slots.

### DETAILED DESCRIPTION

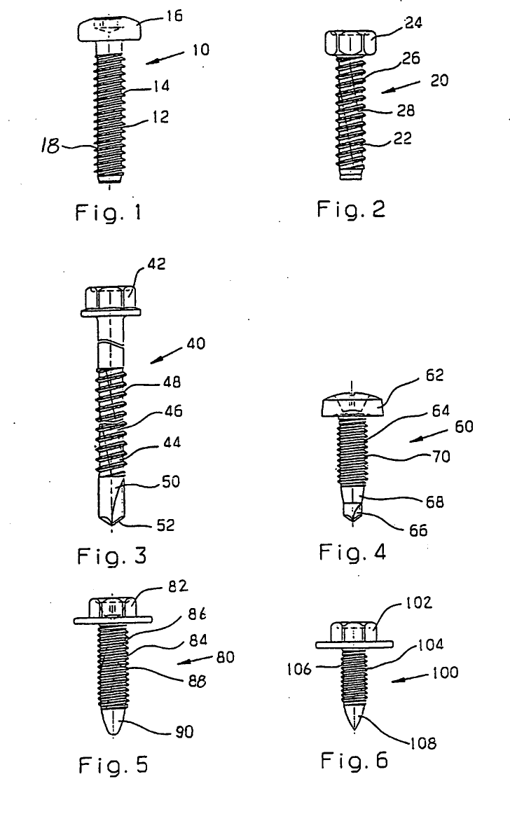

The screw fasteners illustrated in FIGS. 1 to 7 are all manufactured from wrought aluminium alloys; the composition of said alloys lies within the range specified in the foregoing. All the screw fasteners were hot case-hardened by solution annealing, quenching and hot age-hardening and—depending on requirements—subsequently surface-treated.

Thread-forming screw fastener 10 in FIG. 1 has a shaft 12 with external thread 14 and is fitted at one end with head shape 16. The surface of external thread 14 is formed by its flanks 18. When thread-forming fastener 10 is driven into a workpiece, those flanks 18 away from the head of fastener 10 are subject to the greatest load, as these have to perform most of the shaping work during the thread generation process. Fastener 10 is heat-treated in this portion to provide it with maximum strength. It can also be additionally anodised, impregnated with Teflon compound and given a slide coating in this portion or overall. The remainder of fastener 10 is heat-treated so that this portion displays maximum corrosion resistance. The workpiece into which fastener 10 is driven must merely have a hole without an internal thread, as this thread will be formed by fastener 10 itself when it is driven into the hole.

Exactly like thread-forming fastener 10 in FIG. 1, thread-forming screw fastener 20 in FIG. 2 consists of a shaft 22 which is capped at one end by hexagonal head 24. Shaft 22 has an external thread 26 which in contrast to the thread of fastener 10 in FIG. 1 has additional scrape slots 28. These support the process of thread-forming and consist of V-shaped grooves in the flanks of the thread 26 which are aligned longitudinally in a series of scrape slots running one after the other at right angles to the thread flanks. When fastener 20 is driven into a pre-drilled hole, an internal thread is formed in this hole in the same way as is achieved by fastener 10 in FIG. 1. In the case of fastener 20, however, this process is supported by scrape slots 28. At least in that portion of the shaft end away from the head which is largely responsible for thread formation, fastener 20 is also heat-treated in such a way that said portion is provided with maximum strength. It can also be additionally anodised, impregnated with Teflon compound and given a slide coating in this portion or overall. The remainder of fastener 20 is heat-treated so that this portion displays maximum corrosion resistance.

FIG. 3 shows self-drilling screw fastener 40 which, exactly like fastener 20 in FIG. 2, has a shaft 44 capped at one end by head 42; shaft 44 has an external thread 48 with scrape slots 46. At the end away from the head, shaft 44 has a self-drilling cone point 50. The cutting edges 52 of said cone point enable fastener 40 to tap its own hole without pre-drilling when it is driven into a workpiece. Fastener 40 then forms a counter-thread in this self-drilled hole by means of external thread 48 located in the vicinity of cone point 50 on shaft 44. At least cone point 50 is heat-treated in such a way that it is provided with maximum strength. It may also be made of a different, harder material than the wrought aluminium alloy from which the remainder of the fastener is manufactured. The remainder of fastener 40 is heat-treated in such a way that said portion exhibits maximum corrosion resistance.

The thread-forming screw fastener 60 in FIG. 4, which also has a shaft 64 capped by head 62 and a self-drilling cone point 66 at the end of the shaft away from the head, comprises in addition an extrusion hole forming shaft portion 68 between cone point 66 and that portion of the shaft which has an external thread 70. When fastener 60 is driven into a workpiece without a pre-drilled hole, fastener 60 first taps its own hole with cone point 66; this hole is then expanded by the extrusion hole forming portion of shaft 68, whereby a bead is formed around the hole so drilled. If the hole is drilled right through the workpiece, the hole thus becomes longer as a result of this bead. When fastener 60 is driven further into the workpiece, an internal thread is formed both in the self-drilled hole and in the bead, said internal thread being compatible with external thread 70 on fastener 60. Because this internal thread extends into the bead thus formed, it has more supporting turns than would have been the case if the hole in the workpiece had only been tapped by a cone point and not expanded by extrusion hole formation. Fastener 60 is also heat-treated to provide cone point 66 and where necessary extrusion hole forming shaft portion 68 with maximum strength and other portions of the shaft with maximum corrosion resistance. Self-drilling cone point 66 can also be made of a different, harder material than the remainder of the fastener.

FIG. 5 shows screw fastener 80 which, like the other fasteners, has a head 82 and a shaft 84 having an external thread 86. External thread 86 has scrape slots 88. At the end of shaft 84 away from the head, fastener 80 has an extrusion hole forming cone point 90. The fastener is subjected to differentiated heat treatment in a manner similar to the fasteners described above. Extrusion hole forming cone point 90 is suitable for use in pre-drilled sheet metal. When fastener 80 is driven into a workpiece with a pre-drilled hole, extrusion hole forming cone point 90 first expands this hole by displacing the material of the workpiece at the edge. This causes a bead to be formed around the hole, thus extending its overall length. Thread 86 on fastener 80 then forms a compatible internal thread in the hole with the extended bead. Scrape slots 88 support the process.

Like the other fasteners, the screw fastener 100 shown in FIG. 6 has a head 102 and a shaft 104 having an external thread 106. Fastener 100 is subjected to similar differentiated heat treatment as those fasteners described in the foregoing, in order to provide maximum strength in the cone point portion and maximum corrosion resistance in the remainder of the fastener. That end of shaft 104 away from the head has an extrusion hole forming cone point 108. In contrast to the extrusion hole forming cone point 90 in fastener 80 shown in FIG. 5, cone point 108 in fastener 100 is designed in such a way as to permit fastener 100 to be used to join sheet metals without pre-drilled holes. Extrusion hole forming cone point 108 produces this hole while the fastener is being driven into the workpiece by deforming the material originally located in the area of the hole and displacing it to form a bead around the edge. An internal thread corresponding to external thread 106 on fastener 100 is then formed in this hole.

Instead of scrape slots 28 or 88 with their characteristic grooves in the thread flanks, fasteners 20 and/or 80 can also display protrusions or humps such as those which are known from German patent specification no. 27 03 433. Said protrusions or humps are located where the grooves of scrape slots 28 and/or 88 would otherwise be located. Said protrusions or humps extend beyond the nominal diameter of external thread 26 and/or 86, respectively, and are aligned in such a way as to produce several helical lines running round shaft 22 and/or 84 of fastener 20 and/or 80 respectively along which the protrusions or humps are aligned. These helical lines running round the shaft have a lead considerably greater than that of the corresponding thread. When a screw fastener displaying such protrusions or humps is driven into a pre-drilled hole in a workpiece, a clearance thread is produced which considerably reduces the thread-forming torque.

It is also possible, of course, to provide thread-forming fasteners with different geometries which produce a metric thread when these fasteners are driven into a workpiece.

All the fasteners listed can be produced in the same manner.

In the first variation of the method, the fastener in question is first given its appropriate form by pressing the required head shape for the fastener and by generating the required thread geometry on the shaft by either rolling or cutting. This fastener is then pickled and subsequently solution annealed. The temperature applied during solution annealing lies between 470° C. and 520° C. The fastener is then quenched in water after the solution annealing process, followed by hot age-hardening conducted in two stages, followed by hot age-hardening conducted in two stages.

The partial heating for the purposes of portion-by-portion hot age-hardening can be carried out by induction. Induction heating renders it possible to perform the respective steps of the method at different temperatures and above all in a considerably reduced period of time. In particular, induction heating renders it possible to control the heat treatment of a fastener during hot age-hardening in such a way as to provide the fastener with maximum strength in its cone point portion, even if the material at this location consequently displays greater susceptibility to inter-crystalline corrosion, while the remainder of the fastener is heat-treated to provide it with maximum corrosion resistance. To achieve this, heat-treatment of the fastener is differentiated with respect to temperature and time for the separate portions concerned.

In order to increase the strength and hardness of the fastener in the thread flanks portion, a second variation of the method allows the thread geometry to be generated either by rolling or cutting at a later stage, following that of hot age-hardening. This second variation of the process is thus characterized in that initially only the head geometry of the fastener is produced by pressing. The fastener is then pickled, and subsequently hot age-hardened by solution annealing, quenching and heat-curing. Only then is the thread geometry generated.

The subsequent optional treatment to which the fastener is subjected is the same for both variations of the process: its surfaces—particularly those located in the thread flank portion—are first anodised. This process is also known as electrolytic oxidation or hard anodic coating. As a result of anodisation, a particularly hard oxide layer is produced on the surface of the fastener which helps to increase the hardness of the thread flanks, for example up to readings in excess of 350 HV 0.3. Anodisation is best followed by impregnation of the oxide layer thus produced. This can be performed with the aid of Teflon compounds, for example. Finally, the fasteners are given a slide coating in order to reduce even further the friction forces arising during thread-forming. This causes a further marked reduction in plastic deformation of the thread flanks in the course of thread generation while the fastener is being driven into a workpiece.

1-20. (canceled)

21. Thread-forming screw fastener, comprising:
a shaft formed from a heat cured aluminium alloy comprising a screw thread with thread flanks, the shaft having, at one end, a thread-forming portion having a cold-work hardened microstructure formed from precipitation hardened alloy and that provides relatively high strength properties and relatively low corrosion resistance properties, the fastener material otherwise displaying a precipitation hardened microstructure that provides relatively high corrosion resistance properties and relatively low strength properties.

22. Fastener in accordance with claim 21, wherein the fastener material is at least in part of wrought aluminum alloy containing, in addition to aluminum, the following constituents in the concentrations given:

| | |
|---|---|
| Silicon: | 0.1 to 0.5% |
| Iron: | 0 to 0.5% |
| Copper: | 0.5 to 2.5% |
| Manganese: | 0.1 to 0.4% |
| Magnesium: | 2.0 to 3.9% |
| Chromium: | 0 to 0.3% |
| Zinc: | 4.0 to 8.5% |
| Titanium: | 0 to 0.2% |
| Zirconium: | 0 to 0.25%. |

23. Fastener according to claims 21 wherein at least the thread flanks of the fastener are anodised and have the corresponding oxide layers.

24. Fastener according to claim 23, wherein the corresponding oxide layers are provided with an impregnation for reducing friction.

25. Fastener according to claim 24, wherein the oxide layers are impregnated with Teflon compound.

26. Fastener according to claim 21 wherein at least the thread flanks of the fastener have a slide coating.

27. Fastener according to claim 21, wherein the thread-forming portion includes a hole-tapping cone point.

28. Fastener according to claim 21 wherein the thread flanks having protrusions extending beyond the exterior diameter of the thread.

29. Fastener according to claim 28 wherein the protrusions are arranged to produce at least one helical line running round the shaft of the fastener along which the protrusions are aligned, the helical line having a lead that is considerably greater than that of the thread.

30. Fastener according to claim 21 further comprising and wherein the precipitation hardened alloy is pickled, subjected to a solution annealing of the fastener, and subjected to a hot-age hardening before generation of thread geometry.

31. Thread-forming screw fastener, comprising:
a shaft formed from a heat cured aluminium alloy comprising a screw thread with thread flanks, the shaft having, at one end, a thread-forming portion having a cold-work hardened microstructure formed by rolling from precipitation hardened alloy and that provides relatively high strength properties and relatively low corrosion resistance properties, the fastener material otherwise displaying a precipitation hardened microstructure that provides relatively high corrosion resistance properties and relatively low strength properties.

32. Thread-forming screw fastener, comprising:
a shaft formed from a heat cured aluminium alloy comprising a screw thread with thread flanks, the shaft having, at one end, a hole-tapping cone point and an extrusion hole forming portion arranged between the hole tapping cone point and a thread-forming portion having a cold-work hardened microstructure formed from precipitation hardened alloy and that provides relatively high strength properties and relatively low corrosion resistance properties, the fastener material otherwise displaying a precipitation hardened microstructure that provides relatively high corrosion resistance properties and relatively low strength properties.

33. Thread-forming screw fastener, comprising:
a shaft formed from a heat cured wrought aluminium alloy comprising a screw thread with thread flanks, the shaft having, at one end, a thread-forming portion having a cold-work hardened microstructure formed from precipitation hardened alloy and that provides relatively high strength properties and relatively low corrosion resistance properties, the fastener material otherwise displaying a precipitation hardened microstructure that provides relatively high corrosion resistance properties and relatively low strength properties.
